(19) United States
(12) Patent Application Publication
(10) Pub. No.: US 2015/0102777 A1
(43) Pub. Date: Apr. 16, 2015

(54) CASE FOR HOLDING AND RECHARGING ELECTRONIC CIGARETTES

(71) Applicant: IP, LLC, Russell Springs, KY (US)

(72) Inventor: Brian Cooper, Russell Springs, KY (US)

(21) Appl. No.: 14/511,855

(22) Filed: Oct. 10, 2014

Related U.S. Application Data
(60) Provisional application No. 61/890,030, filed on Oct. 11, 2013.

(51) Int. Cl. H02J 7/00

(52) U.S. Cl. CPC H02J 7/0042; H02J 7/0057; H02J 2007/0062
USPC 320/114; 320/137

(57) ABSTRACT

An apparatus is described that comprises a rectangular case comprising a container and a top. The top is rotatably coupled to the container, wherein the interior of the container includes at least one battery, one or more electronic cigarette cartridges and a recharging component. The recharging component includes a USB plug, wherein the USB plug is deployable to engage with a USB port external to the container. The recharging component is coupled to the at least one battery through an electrical coupling. The recharging component is operable to recharge the at least one battery when the USB plug is engaged with the USB port. The top rotatably transitions from a closed position to an open position, the open position exposing the one or more electronic cigarette cartridges and the at least one battery for removal.

### CROSS REFERENCE TO RELATED APPLICATIONS

This application claims the benefit of U.S. Patent Application No. 61/890,030, filed Oct. 11, 2013.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An electronic cigarette (or e-cigarette) provides an alternative to a conventional or traditional tobacco based cigarette. The electronic cigarette provides an electronic inhaler meant to simulate and substitute for tobacco smoking. The electronic cigarette generally utilizes a heating element that vaporizes a liquid solution. Some solutions release nicotine, while others merely release flavored vapor. The electronic cigarette is often designed to mimic traditional smoking implements, such as cigarettes or cigars, in their use and/or appearance. Cases or carrying implements are often provided to house the e-cigarette device in order to provide the look and feel of a traditional pack of cigarettes.

Electronic cigarettes generally include liquid, a cartridge, an atomizer, and a power source. The cartridge generally serves as both a liquid reservoir and mouthpiece (though some devices have separate mouthpieces). It is designed to allow the passage of liquid into the atomizer, and vapour from the atomizer to the user's mouth. Some models employ a tank that holds loose fluid, while some models use a foam material to hold liquid in place. When liquid is depleted, users can refill the cartridge or replace it with another ready-filled cartridge.

The atomizer is the central component of the electronic cigarette. It generally consists of a small heating element responsible for vaporizing liquid, as well as a wicking material that draws liquid into the heating element. “Dripping” atomisers forgo a fluid reservoir, instead requiring periodic manual moistening of the wick.

Electronic cigarettes may include a rechargeable battery or a rechargeable element, which tends to be the largest component of an electronic cigarette. The battery may contain an electronic airflow sensor whereby activation is triggered simply by drawing breath through the device, while other models employ a power button that must be held during operation. Some manufacturers also offer a cigarette pack-shaped portable charging case (PCC), which contains a larger battery capable of charging e-cigarettes. Devices aimed at enthusiasts may sport additional features, such as variable power output and support of a wide range of internal batteries and atomizers.

### BRIEF DESCRIPTION OF THE DRAWINGS

So that the manner in which the present application can be better understood, certain illustrations and figures are appended hereto. It is to be noted, however, that the drawings illustrate only selected embodiments and elements of a case for carrying and recharging electronic cigarettes and are therefore not to be considered limiting in scope for the case and its functionality as described herein may admit to other equally effective embodiments and applications.

FIG. 1 presents a first perspective view of the case for holding e-cigarettes. A hinged top of the case is in its closed position.

FIG. 2 is a front view of the cigarette case of FIG. 1.

FIG. 3 is a rear view of the cigarette case of FIG. 1.

FIG. 4 is a right side view of the cigarette case.

FIG. 5 is a left side view of the cigarette case.

FIG. 6 is a top view of the cigarette case.

FIG. 7 is a bottom view of the cigarette case.

FIG. 8 is a second perspective view of the cigarette case for holding electronic cigarettes. Here, the top of the case is partially opened, exposing an interior.

FIG. 9A is a left side view of the cigarette case, under an embodiment.

FIG. 9B is a top down view of the cigarette case, under an embodiment.

FIG. 9C is a front view of the cigarette case, under an embodiment.

FIG. 9D is a bottom up view of the cigarette case, under an embodiment.

FIG. 9E is a right side view of the cigarette case, under an embodiment.

FIG. 9F is a back view of the cigarette case, under an embodiment.

FIG. 9A is a left side view of the cigarette case, under an embodiment.

FIG. 10 shows the USB plug in a deployed state, under an embodiment.

FIG. 11 shows internal components of the cigarette case under an embodiment.

### DETAILED DESCRIPTION

An electronic cigarette (or e-cigarette) provides an alternative to a conventional or traditional tobacco based cigarette. The electronic cigarette provides an electronic inhaler meant to simulate and substitute for tobacco smoking. Electronic cigarettes include a rechargeable battery (or other power component), which tends to be the largest component of an electronic cigarette.

Cases or carrying implements are often provided to house the e-cigarette device in order to provide the look and feel of a traditional pack of cigarettes. These cases include components of the electronic cigarette including the rechargeable battery. The cases may under one embodiment also include a recharging device or mechanism for charging the battery (or otherwise charging the power component of the electronic cigarette). Under an embodiment, the recharging device or mechanism recharges the battery (or power component) which may then be attached to one or more atomizers and cartridges (or additional components) to form a functioning e-cigarette. Under one embodiment, the battery may include the atomizer or heating element. Alternatively, the cartridges may contain the atomizer or heating element

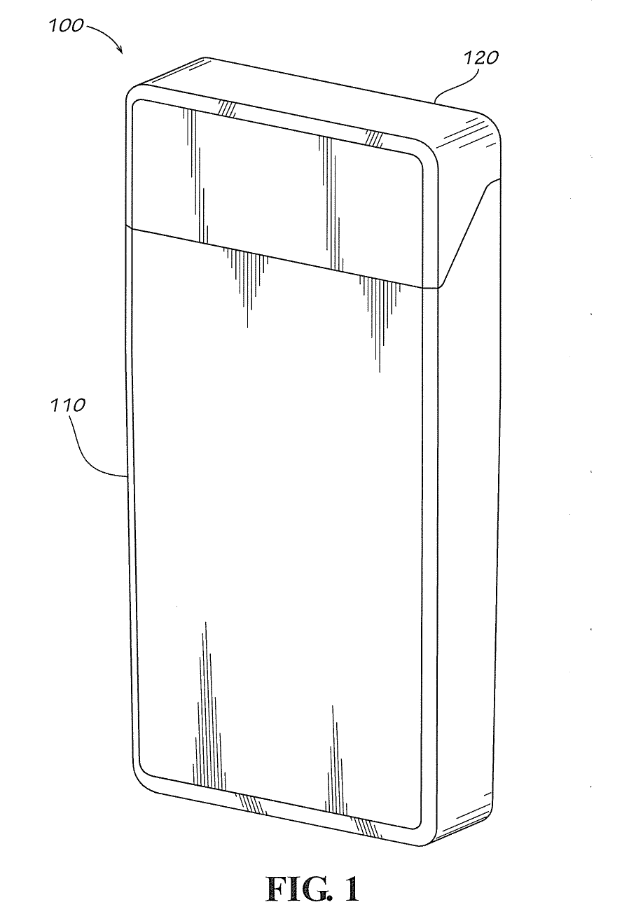

FIG. 1 presents a first perspective view of the case 100 for holding e-cigarettes. The e-cigarette case is dimensioned to approximate the dimensions of a traditional cigarette pack under an embodiment. The case includes a container element 110 and hinged top 120. As seen in FIG. 1 the hinged top of the case is in its closed position. It is understood that the e-cigarette case is not limited to a hinged top but may also include as one example a flip top. As another example, the case may include a removable lid. As yet another example, the case may comprise a lid slidably coupled to the top of the e-cigarette case. Such lid may shift laterally to an “open” position to reveal an interior of the case. Closing such lid comprises shifting or sliding the lid to its original position.

The container element under one embodiment stores the components of one or more e-cigarette components and a USB recharging device/mechanism. The USB charging device/mechanism under one embodiment comprises a USB cable (including a deployable USB plug) and a recharging circuit. The features and functionality of a USB charging mechanism is described in greater detail below. It is understood that embodiments described herein are not limited to a USB recharging mechanism but may also use other recharging systems or mechanisms.

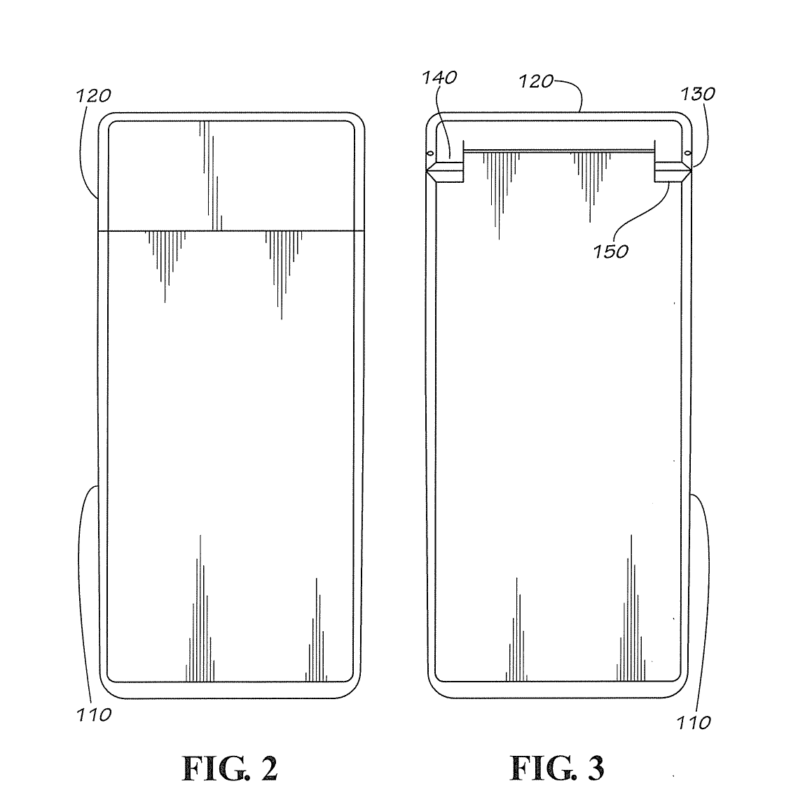

FIG. 2 is a front view of the cigarette case of FIG. 1. This front view shows the hinged top 120 in closed position thereby securing the contents of the case and sealing the contents of the case from exterior elements.

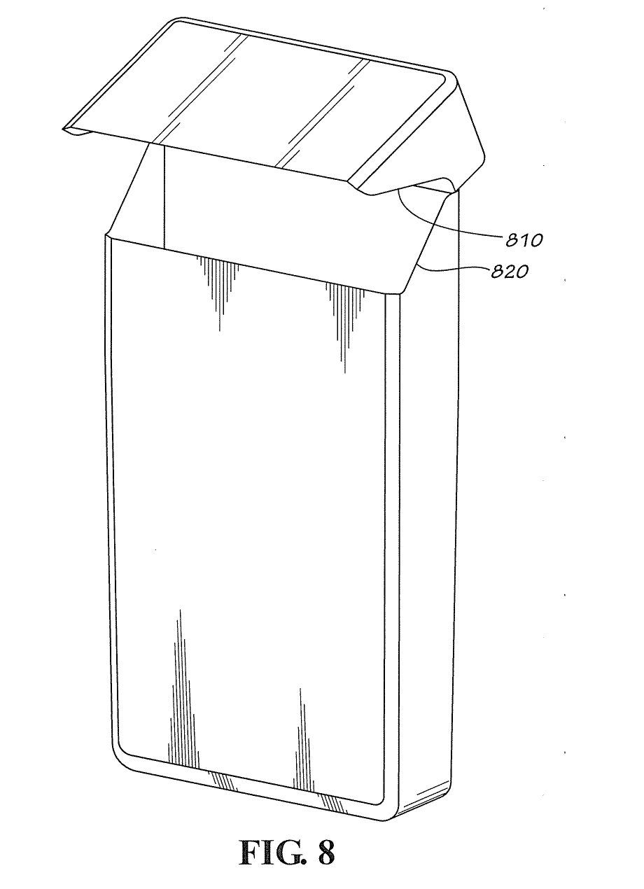

FIG. 3 is a rear view of the cigarette case of FIG. 1. This rear view shows the hinge mechanism of the 130 of the case 100. The hinge comprises a recessed portion 140 of the top and a recessed portion 150 of the container element 110. When the top is in an opened position, a surface of the upper recessed portion 140 engages with the surface of the lower recessed portion 150 to hold and/or maintain the top in the open position as seen in FIG. 8. Referring to FIG. 8, as the hinged top opens, an angle between an edge 810 of the top and edge 820 of the container element increases. Various embodiments of the hinge mechanism provide for various angles. However, in a preferred embodiment, the angle is sufficient to provide easy removal of electronic cigarettes from the container element and easy placement of electronic cigarettes into the container element.

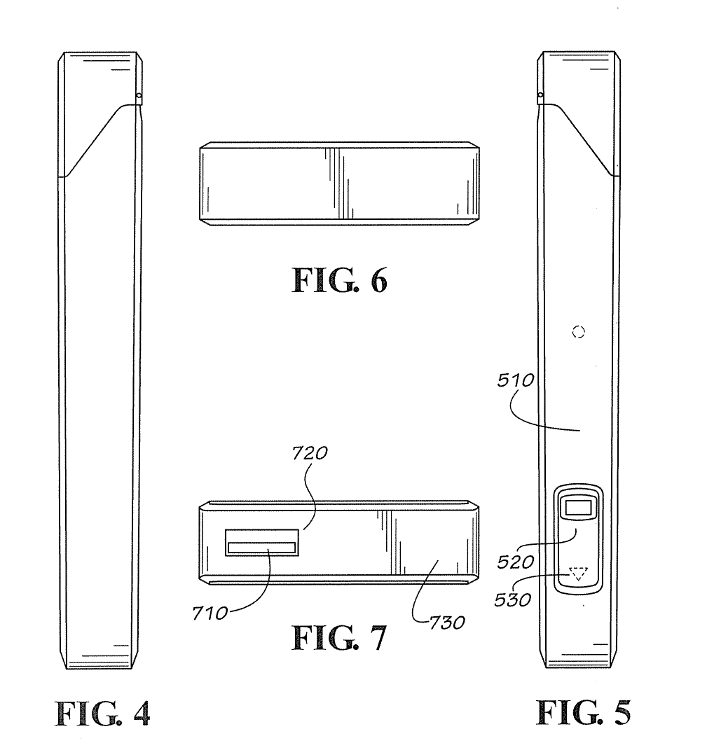

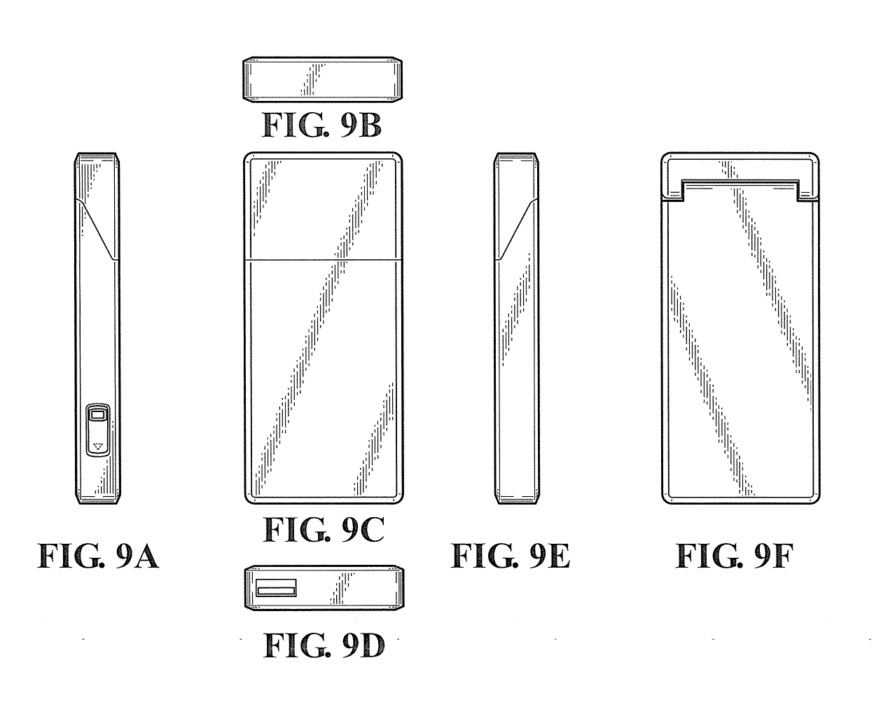

FIG. 4 is a right side view of the cigarette case. FIG. 5 is a left side view of the cigarette case. FIG. 6 is a top view of the cigarette case. FIG. 7 is a bottom view of the cigarette case. FIGS. 9A-9F provides multiple views of the cigarette case in a single figure for ease of reference.

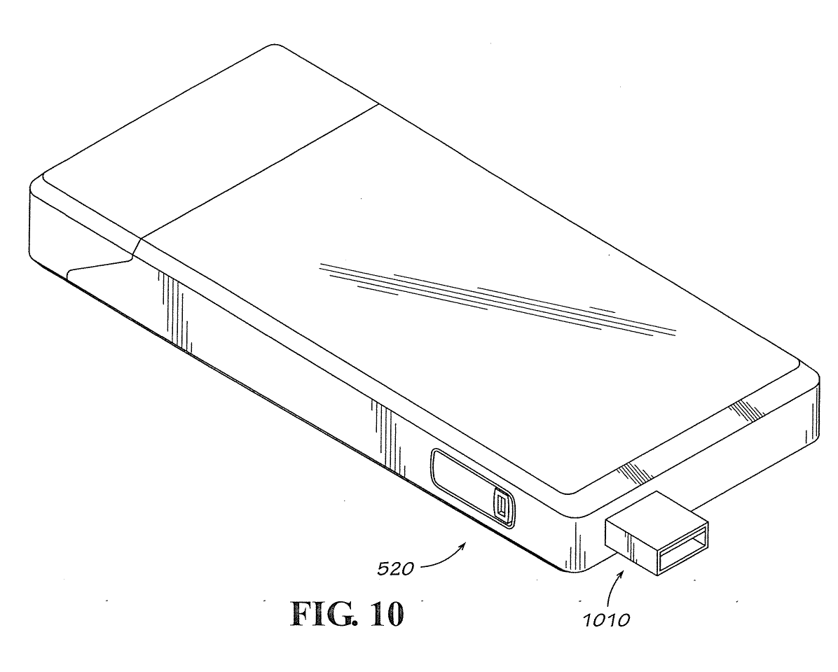

Referring to FIGS. 5, 7, 10, and 11, a USB charging mechanism is now described. As already indicated above, the container element may include a USB charging plug. The USB plug resides in a first (or retracted position) within the container element. Referring to FIG. 7, an opening 720 in a surface 730 of the container element reveals a contact surface or outer edge 710 of a USB plug. In the retracted state, the outer contact surface of the USB plug is approximately parallel to the plane of the opening 720. Referring to FIG. 5, the container element exposes (through an opening) on another surface 510 a slidable button 520. A user may engage the slidable button in order to transition the USB plug from a first or retracted state to a second or deployed state. In the deployed state, the USB plug 1010 extends out from the body of the container (see FIG. 10). The slidable button may include an arrow 530 indicating to the user a direction of USB deployment. In other words, a user slides the button in the direction of the arrow to deploy the USB plug.

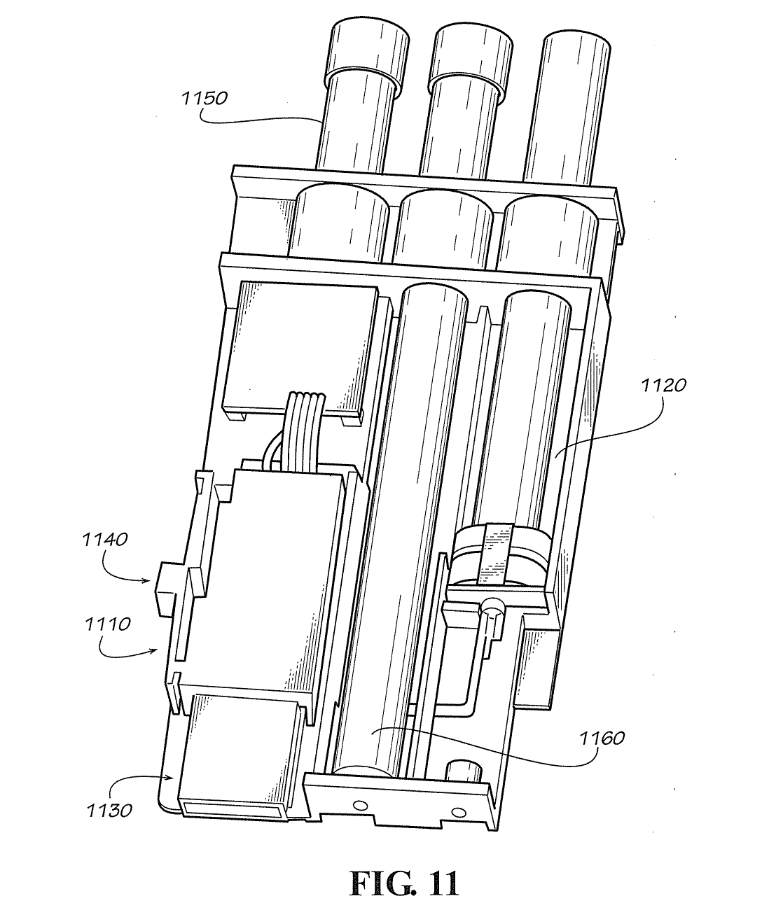

FIG. 11 shows internal components of a cigarette case under one embodiment. FIG. 11 shows components of electronic cigarettes including cartridges 1150 and a battery 1160. The cartridges may function both as mouthpiece and liquid reservoir. FIG. 11 shows a rechargeable battery 1120 and a charging mechanism 1110. FIG. 11 provides storage for one battery 1160 while another battery 1120 recharges. The USB charging mechanism features the deployable USB plug 1130 and a charging circuit coupled to the plug. The USB plug 1130 couples a power source (not shown) to the charging circuit and to the recharging battery 1120 as already described above. A user may engage the slidable button 1140, 520 in order to transition the USB plug 1130 from a first or retracted state to a second or deployed state 1010. In the deployed state, the USB plug 1010 extends out from the body of the container (see FIG. 10). In the deployed state, the USB plug may be coupled to a USB port. As already described above, when the USB plug engages a USB port, the USB recharging mechanism recharges the battery 1120 of the electronic cigarette. When charging is complete, a user may again engage the slidable button to return the USB plug to a retracted state.

FIG. 11 shows storage of one battery 1160 while another battery 1120 recharges. Under one embodiment, the e-cigarette case may provide storage capacity for a greater number of e-cigarette batteries. Further, the charging mechanism of the e-cigarette case may charge two or more rechargeable batteries simultaneously under one embodiment.

In the deployed state, the USB plug may be coupled to a corresponding USB port or connector of a computing or charging device. Universal Serial Bus (USB) is a standard that defines the cables, connectors and communications protocols used in a bus for connection, communication, and power supply between computers and electronic devices.

The USB interface standardizes the connection of computer peripherals (including keyboards, pointing devices, digital cameras, printers, portable media players, disk drives and network adapters) to personal computers, both to communicate and to supply electric power.

In general, there are three basic kinds or sizes related to the USB connectors and types of established connection. One size comprises the “standard” size, in its USB 1.1/2.0 and USB 3.0 variants (for example, on USB flash drives). One size comprises the “mini” size (primarily for the B connector end, such as on many cameras). Once size comprises the “micro” size, in its USB 1.1/2.0 and USB 3.0 variants (for example, on most modern cellphones).

Unlike other data cables (Ethernet, HDMI etc.), each end of a USB cable uses a different kind of connector: an A-type or a B-type. This kind of design was chosen to prevent electrical overloads and damaged equipment, as the A-type socket provides power under one an embodiment. USB cables generally comprise the A-type and B-type plugs, and the corresponding receptacles or ports are on the computer or electronic device. In common practice, the A-type connector is usually the full size, and the B-type side can vary as needed.

The mini and micro sizes also allow for a reversible AB-type receptacle, which can accept either an A-type or a B-type plug. This scheme, known as “USB On-The-Go”, allows one receptacle to perform its double duty in space-constrained applications under one embodiment.

USB connections also come in four data transfer speeds: Low Speed, Full Speed, High Speed and SuperSpeed. High Speed is only supported by specifically designed USB 2.0 High Speed interfaces (that is, USB 2.0 controllers without the High Speed designation do not support it), as well as by USB 3.0 interfaces. SuperSpeed data rates are supported only by USB 3.0 interfaces.

Under one embodiment, the USB plug 1130 comprises a standard size A-type connector which then couples to or connects with a corresponding USB port of a computing or recharging device. Under such embodiment a USB cable (or other electrical coupling) connects the A-type standard size plug to a mini or micro size type B connector. Under this embodiment, the mini or micro size type B connector couples or connects to a charging circuit which manages the voltage presented to the recharging battery and current delivered to the recharging battery. Under one embodiment, the charging circuit functions to recharge a battery. Such batteries may include 300 mAh or 650 mAh batteries but embodiments are not so limited. Such batteries may comprise lead-acid, nickel cadmium (NiCd), nickel metal hydride (NiMH), lithium ion (Li-ion), and lithium ion polymer (Li-ion polymer) but embodiments are not so limited. It should be noted that the charging components of an e-cigarette case may use various USB cables featuring various combinations of type A and type B plugs (of the USB 1.1/2.0 and USB 3.0 variants) and corresponding connectors to couple a power source to a recharging battery. Under one embodiment, the recharging mechanism of the e-cigarette case may charge two or more batteries simultaneously.

When the USB plug engages a USB port as described above, the USB recharging mechanism recharges a battery of the electronic cigarette. FIG. 10 shows the USB plug 1010 in a deployed state capable of engaging with a USB port. When charging is complete, a user may again engage the slidable button 520 to return the USB plug to a retracted state.

From the perspective of a user, a user engages the slidable button to deploy the USB plug. The user then couples the USB plug with an available USB port such as a USB port of a personal computer or other computing/charging device. The USB charging mechanism then charges a battery contained within the container element. Once the charging process is complete, the user disengages the USB plug from the USB port. The user may now open the hinged top/lid and remove the battery and additional cigarette components for use.

Under one embodiment the slidable button 520 may comprise a light indicator coupled to an internal charging mechanism of the case including a charging circuit which regulates charge cycles of the rechargeable battery. The charging circuit may direct current to the light indicator during a charge cycle. Therefore, an illuminated slidable button 520 indicates that battery is currently charging. When the charging process is complete (or when the charge of the case's battery equals or exceeds a pre-determined level), the charging circuit may terminate the flow of current to the light indicator, i.e. switch off the light indicator to signal a charged state. Under one alternative embodiment, a light source may simply reside within the case (e.g. an LED light on a charging circuit in proximity to a slidable button 520) and indirectly illuminate translucent material of a slidable button 520.

Under one embodiment, the e-cigarette case may include a monitoring component to monitor and store information of its general use and operation. The monitoring component may include one or more microprocessors and/or microcontrollers. The monitoring component may be coupled to local memory storage components and may read and write data to and from such storage components. The monitoring component may itself comprise the charging circuit or otherwise couple and communicate with the charging circuit.

As just one example of monitored data, the monitoring component may track the number of charge cycles implemented by the charging circuit. As another example, the monitoring component may monitor the electrical properties of a battery and charging circuit during a discrete charging cycle. This information may be stored locally or transmitted to remote devices.

Under an embodiment, the monitoring component includes a wireless module for communication with remote devices including personal computers, tablets, laptops and mobile computing devices. The wireless module may wirelessly couple with remote devices using one or more wireless communication protocols including WiFi, Zigbee, Z-Wave and Bluetooth. Remote devices may then receive monitored data and use such information to enhance the functionality of the e-cigarette case. As one example, the wireless module may wirelessly couple with a user's smartphone. The wireless module then transmits information of an e-cigarette case to the smartphone. A corresponding application running on the smartphone platform processes/interprets the data to trigger alerts and recommendations to a user.

As one example, the wireless module may transmit to a smartphone data indicating commencement and conclusion of discrete charge cycles. The application may then alert the user (via email, text or other notification) that a charge cycle is complete and that a recharging battery is ready for use. As another example, the wireless module may transmit data indicating electrical properties of a battery and charging circuit observed during a charge cycle. The application may then interpret the electrical properties to diagnose the health and expected life of the battery. Under an embodiment, the application may provide battery life estimates to the user. The application may also report levels of charge upon completion of charge cycle or simply recommend battery replacement when a battery's charge capacity drops below a predetermined level.

The wireless module of the e-cigarette case may simply track the number of charge cycles completed over time and transmit this information to a user's smartphone. Assuming an approximate number of cartridges that a user may consume with the power of a single recharged battery, an application may track/monitor a user's consumption rate of e-cigarette liquid cartridges.

Under another embodiment, the wireless module wirelessly couples with a user's Local Area Network (LAN) which is further communicatively coupled to a wide area network (WAN) and the internet in general. The coupling to a WAN may provide communications between the wireless module and a remote server. The wireless module may communicate to a remote server (via such LAN-WAN coupling) the electrical properties associated with charge cycles as already described above. One or more applications running on a remote server may store, process and take action upon received data. Under one embodiment a remote server may report such data to mobile computing platforms for real time viewing/access by users of the e-cigarette case.

Under another embodiment, an e-cigarette case may include a GPS transceiver. The GPS transceiver may receive/compute positioning data of the e-cigarette case and transmit positioning data to a remote server using wireless cellular networks or Wi-Fi hotspots or other communication pathways. One or more applications running on a remote server may then provide this positioning information to mobile computing platforms of a user. The positioning data may assist a user in locating a lost e-cigarette case. Further, positioning data may pair with monitored e-cigarette usage to identify times and physical locations of e-cigarette usage. Such data may be used to develop marketing campaigns which place advertising content and/or merchandise in locations corresponding to physical presence of active e-cigarette users.

It is understood that the case for carrying and charging electronic cigarettes as set forth in FIGS. 1-11 and the method for using the case and e-cigarettes are merely illustrative. Other arrangements may be employed in accordance the embodiments set forth below. Further, variations of electronic cigarette case may comply with the spirit of the embodiments set forth herein.

An apparatus is described herein that includes a rectangular case comprising a container and a top. The top is rotatably coupled to the container. The interior of the container includes at least one battery, one or more electronic cigarette cartridges and a recharging component. The recharging component includes a USB plug, wherein the USB plug is deployable to engage with a USB port external to the container. Under an embodiment, the recharging component is coupled to the at least one battery through an electrical coupling. The recharging component is operable to recharge the at least one battery when the USB plug is engaged with the USB port. Under an embodiment, the top is configured to rotatably transition from a closed position to an open position.

Under an embodiment, the at least one battery is rechargeable.

Under an embodiment, the open position exposes the one or more electronic cigarette cartridges and the at least one battery for removal.

Under an embodiment, the container exposes a slidable button on a first side of the container.

Under an embodiment, slidable button is coupled to or integrally formed with the USB plug.

Under an embodiment, wherein the container comprises an opening on a second side of the container.

Under an embodiment, the USB plug is positioned in a first state within the container.

Under an embodiment, the contact face of the USB plug in the first state is approximately parallel with the plane of the opening.

Under an embodiment, the engaging the exposed slidable button transitions the USB plug from the first state and through the opening to a second state, wherein the second state comprises the deployed USB plug.

Under an embodiment, the second state comprises a contact portion of the USB plug extending beyond the plane of the opening, wherein the contact portion includes the contact face.

Under an embodiment, the recharging component includes a charging circuit.

Under an embodiment, the charging circuit regulates a charge cycle of the at least one battery.

Under an embodiment, the USB plug comprises a standard size type A plug.

Under an embodiment, the recharging component includes a type B plug connected to the USB plug through a USB cable, the type B plug comprising a mini USB plug or a micro USB plug.

Under an embodiment, the type B plug is coupled to the charging circuit.

Under an embodiment, the rectangular case is dimensioned to approximate the dimensions of cigarette pack.

The method of an embodiment described herein includes placing one or more e-cigarette cartridges and at least one rechargeable battery into a rectangular case, wherein the rectangular case includes a recharging component, wherein the recharging component includes a USB plug, wherein the recharging component is coupled to the at least one rechargeable battery through an electrical coupling. The method of an embodiment comprises engaging a slidable button that is exposed on a first side of the container, wherein the slidable button is coupled to the USB plug, wherein the engaging the exposed slidable button extends a contact portion of the USB plug through an opening in a second side of the container. The method of an embodiment includes coupling the extended contact portion of the USB plug with a USB port, the recharging component recharging the at least one rechargeable battery when the USB plug is engaged with the USB port. The method of an embodiment includes decoupling the extended contact portion of the USB plug from the USB port when the at least one rechargeable battery is recharged and engaging the slidable button to retract the USB plug within the rectangular case. The method of an embodiment includes removing the one or more electronic cigarette cartridges and a recharged battery of the at least one rechargable battery for use.

Under an embodiment, the extending the contact portion of the USB plug includes transitioning the USB plug from a first state to a second state, wherein a contact face of the USB plug in the first state is approximately parallel with the plane of the opening, wherein the second state comprises an extension of the contact portion of the USB plug through the opening, wherein the contact portion comprises the contact face.

Under an embodiment, the recharging component includes a charging circuit.

Under an embodiment, the charging circuit regulates a charge cycle of the at least one battery.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The components of the e-cigarette case (and corresponding remote computing devices) can be a component of a single system, multiple systems, and/or geographically separate systems. The components of the e-cigarette case (and corresponding remote computing devices) can also be a subcomponent or subsystem of a single system, multiple systems, and/or geographically separate systems. The components of the e-cigarette case (and corresponding remote computing devices) can be coupled to one or more other components (not shown) of a host system or a system coupled to the host system.

One or more components of the e-cigarette case (and corresponding remote computing devices) and/or a corresponding interface, system or application to which the one or more components of the e-cigarette case (and corresponding remote computing devices) is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the components of the e-cigarette case (and corresponding remote computing devices) can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the components of the e-cigarette case (and corresponding remote computing devices) and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the components of the e-cigarette case (and corresponding remote computing devices) and corresponding systems and methods include: microcontrollers with memory (such as electronically erasable programmable read only memory (EEPROM)), embedded microprocessors, firmware, software, etc. Furthermore, aspects of the components of the e-cigarette case (and corresponding remote computing devices) and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the components of the e-cigarette case (and corresponding remote computing devices) and corresponding systems and methods is not intended to be exhaustive or to limit the systems and methods to the precise forms disclosed. While specific embodiments of, and examples for, the components of the e-cigarette case (and corresponding remote computing devices) and corresponding systems and methods are described herein for illustrative purposes, various equivalent modifications are possible within the scope of the systems and methods, as those skilled in the relevant art will recognize. The teachings of the components of the e-cigarette case (and corresponding remote computing devices) and corresponding systems and methods provided herein can be applied to other systems and methods, not only for the systems and methods described above.

The elements and acts of the various embodiments described above can be combined to provide further embodiments. These and other changes can be made to the components of the e-cigarette case (and corresponding remote computing devices) and corresponding systems and methods in light of the above detailed description.

1. An apparatus comprising:
a rectangular case comprising a container and a top, the top rotatably coupled to the container, wherein the interior of the container includes at least one battery, one or more electronic cigarette cartridges and a recharging component, wherein the recharging component includes a USB plug, wherein the USB plug is deployable to engage with a USB port external to the container;
the recharging component coupled to the at least one battery through an electrical coupling;
the recharging component operable to recharge the at least one battery when the USB plug is engaged with the USB port;
the top configured to rotatably transition from a closed position to an open position.

2. The apparatus of claim 1, wherein the at least one battery is rechargeable.

3. The apparatus of claim 1, wherein the open position exposes the one or more electronic cigarette cartridges and the at least one battery for removal.

4. The apparatus of claim 1, wherein the container exposes a slidable button on a first side of the container.

5. The apparatus of claim 4, wherein the slidable button is coupled to or integrally formed with the USB plug.

6. The apparatus of claim 5, wherein the container comprises an opening on a second side of the container.

7. The apparatus of claim 6, wherein the USB plug is positioned in a first state within the container.

8. The apparatus of claim 7, wherein a contact face of the USB plug in the first state is approximately parallel with the plane of the opening.

9. The apparatus of claim 8, wherein engaging the exposed slidable button transitions the USB plug from the first state and through the opening to a second state, wherein the second state comprises the deployed USB plug.

10. The apparatus of claim 9, wherein the second state comprises a contact portion of the USB plug extending beyond the plane of the opening, wherein the contact portion includes the contact face.

11. The apparatus of claim 10, wherein the recharging component includes a charging circuit.

12. The apparatus of claim 11, wherein the charging circuit regulates a charge cycle of the at least one battery.

13. The apparatus of claim 1, the USB plug comprising a standard size type A plug.

14. The apparatus of claim 1, the recharging component including a type B plug connected to the USB plug through a USB cable, the type B plug comprising a mini USB plug or a micro USB plug.

15. The apparatus of claim 14, wherein the type B plug is coupled to the charging circuit.

16. The apparatus of claim 1, wherein the rectangular case is dimensioned to approximate the dimensions of cigarette pack.

17. A method comprising:
placing one or more e-cigarette cartridges and at least one rechargeable battery into a rectangular case, wherein the rectangular case includes a recharging component, wherein the recharging component includes a USB plug, wherein the recharging component is coupled to the at least one rechargeable battery through an electrical coupling;
engaging a slidable button that is exposed on a first side of the container, wherein the slidable button is coupled to the USB plug, wherein the engaging the exposed slidable button extends a contact portion of the USB plug through an opening in a second side of the container;
coupling the extended contact portion of the USB plug with a USB port, the recharging component recharging the at least one rechargeable battery when the USB plug is engaged with the USB port;
decoupling the extended contact portion of the USB plug from the USB port when the at least one rechargeable battery is recharged;
engaging the slidable button to retract the USB plug within the rectangular case;
removing the one or more electronic cigarette cartridges and a recharged battery of the at least one rechargable battery for use.

18. The method of claim 1, wherein the extending the contact portion of the USB plug includes transitioning the USB plug from a first state to a second state, wherein a contact face of the USB plug in the first state is approximately parallel with the plane of the opening, wherein the second state comprises an extension of the contact portion of the USB plug through the opening, wherein the contact portion comprises the contact face.

19. The method of claim 1, wherein the recharging component includes a charging circuit.

20. The method of claim 19, wherein the charging circuit regulates a charge cycle of the at least one battery.
